(19) United States
(12) Patent Application Publication
(10) Pub. No.: US 2014/0169044 A1
(43) Pub. Date: Jun. 19, 2014

(54) SELF-EXCITATION PUSH-PULL TYPE CONVERTER

(71) Applicant: Baojun Wang, Guangzhou (CN)

(72) Inventor: Baojun Wang, Guangzhou (CN)

(21) Appl. No.: 13/979,654

(22) PCT Filed: Jan. 12, 2012
(86) PCT No.: PCT/CN12/70262

§ 371 Date: Jul. 15, 2013

(30) Foreign Application Priority Data
Aug. 26, 2011 (CN) 201110247645.1

(51) Int. Cl. H02M 3/338; H02M 3/335

(52) U.S. Cl. CPC H02M 3/3382; H02M 3/33538
USPC 363/22

(57) ABSTRACT

A self-excited push-pull converter, comprising a Jensen circuit, characterized in that a two-terminal network with an electrical property of passing high frequencies and blocking low frequencies exists between a terminal of a magnetic saturation transformer primary winding and a terminal of a main transformer primary winding in said Jensen circuit, i.e. said magnetic saturation transformer primary winding is connected in parallel with said main transformer primary winding through said two-terminal network. The self-excited push-pull converter of the present invention has a good self-protection capability and can be restored by itself to normal operation after overcurrent and short circuit disappear.

### TECHNICAL FIELD

The present invention relates to a self-excited push-pull converter, and more specifically, to a self-excited push-pull converter for the industrial control and lighting industry.

### BACKGROUND

The circuit design of today's self-excited push-pull converters partially comes from the self-excited oscillating push-pull transistor single-transformer DC converter invented by American G. H. Royer in 1955, which is usually referred to as Royer circuit for short and which marks the beginning of high-frequency conversion control circuits. In 1957, American Jen Sen invented the self-excited push-pull dual-transformer circuit, which is later referred to as self-oscillating Jensen circuit, self-excited push-pull Jensen circuit or Jensen circuit. These two types of circuits are later collectively called “self-excited push-pull converters” in the art.

Description of the self-excited push-pull converter can be found in pages 67-70 of Principles & Design of Switching Mode Power Supply, a book published by Publishing House of Electronics Industry and with an ISBN of 7-121-00211-6. Main circuit forms are the well-known Royer circuit and self-oscillating Jensen circuit. Compared with the Royer circuit operating under the same conditions, the Jensen converter has a relatively stable self-oscillating frequency when supply voltage, load and temperature are undergoing changes.

The self-oscillating Jensen circuit is as shown in FIG. 3-11 in page 69 of Principles & Design of Switching Mode Power Supply. To facilitate description, FIG. 3-11 is substantially reproduced here as FIG. 1. The original figure in the book has a mistake in the output rectification portion, where diode D1 and diode D2 are shown to be connected with a pair of dotted terminals. In fact, this is a well-known full-wave rectifier circuit, and diode D1 and diode D2 should be connected with a pair of undotted terminals. This error has however been corrected in FIG. 1.

The book Principles & Design of Switching Mode Power Supply also describes on page 70 a current drive Jensen circuit (see the book, FIG. 3-12(a) and FIG. 3-12(b)), wherein the circuit in FIG. 3-12(a) is just a transition circuit diagram illustrating principles and is not used “as is” in practice. The following is excerpt from the book, lines 2-5, page 70:

“In case of light load, i_{c} is small while Iₘ₂ becomes large; if i_{b} is made small, then a base driving current is insufficient, a large voltage drop is caused at a switching tube, magnetic saturation of a transformer T2 cannot be maintained, and huge energy consumption is produced on the switching tube. To eliminate this problem, Iₘ₂ has to be compensated, i.e. an additional winding Nm is added at T₂, just as shown in FIG. 3-12(b).”

That means that FIG. 3-12(b) is the real circuit that can be put into practical use. In order to facilitate description, FIG. 3-12(b) is substantially reproduced here as FIG. 2.

In earlier papers, the self-oscillating Jensen circuit is called inverse dual-converter push-pull circuit, which has been described on pages 70 to 72 of Power Supply Conversion Technology by Posts and Telecommunications Press (ISNB of 7-115-04229-2/TN•353). A circuit discussed in the book is shown in FIG. 2-40 on page 71. To facilitate description, this figure is substantially reproduced as FIG. 3 in this application.

There is further a typical form of application of the Jensen circuit widely applied in micropower module DC/DC converters, see FIG. 4, (where a circuit associated with the secondary coil output is not shown), a starting circuit is added when compared with the circuit in FIG. 1 (however, in practice, the circuits in FIG. 1 and FIG. 2 should also include a starting circuit). In FIG. 4, resistor R1 and capacitor C1 constitute the starting circuit.

FIG. 5 is another typical form application of the Jensen circuit. As compared with the circuit in FIG. 4, the other terminal of capacitor C1 is grounded. When a voltage inputted to the circuit is relatively high, it could prevent capacitor C1, at the moment of switching on, from producing impact on the bases and emitters of triodes TR1 and TR2 working as a push-pull switch. When the circuit's power supply is switched on, as voltages at the two terminals of capacitor C1 cannot jump, the circuit in FIG. 5 realizes a soft start-up function.

Nonetheless, the Jensen circuit in the prior art has the following disadvantages:

1. Poor Self-Protection Capability

Detailed description is presented from line 6 to the paragraph end on page 70 of Principles & Design of Switching Mode Power Supply, which is quoted as below: “However, a proportional current drive circuit has a disadvantage, because when a Royer converter is short-circuited, the circuit will stop oscillation and causes two primary switches to be in off status. A Royer circuit can be said to have a self-protection capability. Although the Jensen converter shown in FIG. 3-12 can achieve self-protection to some extent in case of overload, it is unlike the circuit shown in FIG. 3-11, which achieves good self-protection in all cases of output current overload. In the circuit shown in FIG. 3-12, other than the case of output solid short circuit, output overload self-protection does not exist, because with the increase of the load value, I_{b} increases proportionally as well. Therefore, the characteristic of proportional current drive will cause a switching collector current to reach a peak value. If there is no external protection device to turn off the switching tube, it will be damaged.”

The above-mentioned FIG. 3-12 corresponds to FIG. 2 of the present invention, and the above-mentioned FIG. 3-11 corresponds to FIG. 1 of the present invention.

The protection is off-type. When the output is overcurrent and short-circuited, i.e. when a load current reaches a certain value, the primary current can no longer increase any more as being restricted by a triode. That is to say, the exciting current of transformer T1 in the circuits shown in FIGS. 1 and 2 is equal to zero, the transformer fails to work, and the transistor cannot be saturation switched on as failing to obtain a feedback voltage, and the circuit thus can no longer work. As mentioned above, neither of the circuits in FIGS. 1 and 2 has an auxiliary starting circuit. In practical use, if the circuits in FIGS. 1 and 2 are literally adopted, when the circuits are powered on, they cannot enter a self-excited push-pull working state, so an auxiliary starting circuit must be added. However, if the auxiliary starting circuit functions only at the moment of power on and no longer produce any effect after the circuit (as in FIG. 1 or FIG. 2) enters exciting push-pull work, then the circuit will produce the second disadvantage as described below.

2. Once the output is short-circuited, the circuit stops oscillation, and two push-pull triodes are both in off status. After the output overcurrent and short circuit disappear, the circuit cannot restore to normal working status. This can be easily verified through experiment by those of ordinary skill in the art.

Of course, by using a line auxiliary starting circuit shown in FIGS. 3, 4 and 5, after the output short circuit disappears, the circuit can restore to normal working status. However, this causes a new disadvantage as described below.

3. With respect to the existing Jensen circuit shown in FIGS. 3, 4 and 5, when the output is overcurrent and short-circuited, triodes TR1 and TR2 generate a large amount of heat and will be easily burned.

For a transformer, if the secondary load current increases, then the primary current increases as well, while the exciting current is essentially unchanged. In FIGS. 3, 4 and 5, resistor R1 is used for providing a base current to triodes for push-pull usage. When the output is overcurrent and short-circuited (i.e., the load current reaches a certain large value), the primary current cannot increase an more as being restricted by triodes (i.e., the exciting current of a transformer T2 is equal to zero), the transformer then fails to work, the transistor cannot be saturation switched on as failing to obtain a feedback voltage, and the circuit will stop working (i.e., the circuit stops oscillation). Theoretically, the working current of the whole circuit at this moment is:

$${I}_{( TR 1 + TR 2 )} \approx \frac{SupplyVoltage - 0.7 V}{R 1} \times β \qquad Equation ( 1 )$$

β is an amplification factor of triodes TR1 and TR2, 0.7V is a forward voltage drop from the base to the emitter of a commonly used silicon NPN-type triode, I is the circuit's joint working current and is sourced, after the circuit stops oscillation, from a base current that is supplied by the power supply supplies via resistor R1 to triodes TR1 and TR2 and that is amplified by triodes TR1 and TR2. Here, the amplification factors of triodes TR1 and TR2 are taken as substantially equal and, if they are not equal, then their mean value may be used. With respect to a commonly used circuit, when the circuit stops oscillation, a collector-to-emitter voltage of triodes TR1 and TR2 is equal to a supply voltage. Due to the existence of an auxiliary starting circuit R1, a base current is supplied to triodes TR1 and TR2 and, after amplification by triodes TR1 and TR2, this current becomes very large. The collector-to-emitter voltage of triodes TR1 and TR2 is equal to the supply voltage. However, since the circuit stops oscillation, triodes TR1 and TR2 cannot work in a saturated status. At this moment, the amount of heat produced by triodes TR1 and TR2 is considerable, and the two triodes can be burned in a short time.

If a 5V-to-5V DC/DC converter is made based on the circuit shown in FIG. 4, with a power of 1 W (i.e., output current is 200 mA), then the circuit's typical parameters would be: Vin is 5V, resistor R1 is 2.2 KΩ, Rb is 2.2 KΩ triodes TR1 and TR2 use T0-92 packaged 2N5551, the maximum collector working current is 600 mA, the maximum collector consumption is 625 mW, and an amplification factor is 180. If at this moment the output is short circuited and the circuit stops oscillation, then the circuit's working current would be calculated according to Equation (1):

$${I}_{( TR 1 + TR 2 )} \approx \frac{5 V - 0.7 V}{1000 Ω} \times 180 = 774 mA$$

At this moment, the all consumption (Pₐₗₗ) of triodes TR1 and TR2 is:

P_{all≈}U_{supply voltage}e×I_{(TR1+TR2)}=5V×774 mA=3870 mW

The consumption of each electrode tube is half, i.e. 1935 mW, far exceeding the maximum collector consumption of 625 mW of the 2N5551 triode. Under an actual testing, the 2N5551 triode was burned in 2 seconds.

This is just for a 5V-to-5V DC/DC converter with a power of 1 W. In practical applications, most circuits work under a higher voltage and larger power. As such, for the prior art Jensen circuit, the caloric value of triodes TR1 and TR2 is even more considerable and the triodes will be more easily burned when the output is overcurrent and short-circuited.

4. The existing circuits in the prior art for solving disadvantages 1, 2 and 3 are too complex.

If the added auxiliary starting circuit in FIGS. 1 and 2 functions only when power on and no long functions after the circuits enter self-excited push-pull work, the circuit will stop oscillation upon occurrence of short circuit. Therefore, a very complex auxiliary starting circuit must necessarily be designed and employed so that, following a occurrence of short circuit and non-oscillation, when the short circuit disappears, the complex auxiliary starting circuit can trigger the circuit to start self-excited push-pull work again. Due to the design complexity, those of ordinary skill in the art generally resort to other switching mode power supply circuit topologies.

### SUMMARY

It is an object of the present invention to provide a self-excited push-pull converter, which can solve the foregoing described problems. By means of a simple circuit, a self-excited push-pull Jensen circuit according to the present invention can be made to have a good self-protection capability and can be self-restored to normal operation after the condition of overcurrent and short circuit disappears.

The object of the present invention is achieved by the following technical solution:

A self-excited push-pull converter comprises a Jensen circuit, wherein a two-terminal network with an electrical property of passing high frequencies and blocking low frequencies is disposed between a terminal of a magnetic saturation transformer primary winding and a terminal of a main transformer primary winding in a Jensen circuit, that is, the magnetic saturation transformer primary winding is connected in parallel with the main transformer primary winding through the two-terminal network.

Preferably, said two-terminal network is a capacitor.

Preferably, said two-terminal network is formed by a capacitor connected in parallel with a resistor.

Preferably, said two-terminal network is formed by a capacitor connected in series with a resistor.

Preferably, said two-terminal network is formed by more than one capacitor connected with more than one resistor in parallel, in series, or a mix of parallel and series.

Preferably, said two-terminal network is formed by a capacitor connected in series with an inductor.

Preferably, said two-terminal network is formed by a capacitor connected in parallel with an inductor.

As further improvement to the foregoing technical solution, a capacitor is connected in parallel at the magnetic saturation transformer primary winding.

Compared with the prior art, the present invention has advantageous effects as described below:

The present invention replaces a feedback resistor in the existing Jensen circuit by a two-terminal network with the electrical property of passing high frequencies while blocking low frequencies. As a result, the self-excited push-pull converter has a good self-protection capability and, in case of output overcurrent and short circuit, does not enter an oscillation stop state but enters a high-frequency self-excited working state. It ensures that the pair of triodes operating in push-pull will not be burned by overheating when the converter output is overcurrent and short-circuited, and can be restored to normal operation after the condition of overcurrent and short circuit disappears.

In addition, by connecting in parallel a capacitor at the primary winding of the magnetic saturation transformer, the self-excited push-pull converter will have its high-frequency self-excited oscillating frequency within the range of designed values when the output is overcurrent and short-circuited. Further, the converter has such characteristics as offering consistent performance of short circuit protection and being easy to perform adjustment.

### BRIEF DESCRIPTION OF THE SEVERAL VIEWS OF THE DRAWINGS

FIG. 1 is a reproduction of FIG. 3-11 from page 69 of Principles & Design of Switching Mode Power Supply.

FIG. 2 is a reproduction of FIG. 3-12(b) from page 70 of Principles & Design of Switching Mode Power Supply.

FIG. 3 is a reproduction of FIG. 2-40 from page 71 of Power Supply Conversion Technology.

FIG. 4 is a schematic circuit diagram of a common Jensen circuit used in the industry in the prior art.

FIG. 5 is a schematic circuit diagram of another common Jensen circuit in the industry in the prior art.

FIG. 6 is a schematic circuit diagram of Embodiment 1 of the present invention.

FIG. 7 is an oscillogram of triode TR1 collector during normal operation according to Embodiment 1 of the present invention.

FIG. 8 is a known equivalent schematic circuit diagram of an inductor.

FIG. 9 is an equivalent schematic circuit diagram in high-frequency oscillation according to Embodiment 1 of the present invention.

FIG. 10 is a diagram of a relationship between frequency and impedance Z of a capacitor.

FIG. 11 are schematic circuit diagrams of six embodiments of a two-terminal network according to the present invention.

FIG. 12-1 is a schematic circuit diagram of an embodiment of a two-terminal network according to the present invention.

FIG. 12-2 is a diagram of a relationship between frequency and impedance Z of an LC series loop.

FIG. 13-1 is a schematic circuit diagram of an embodiment of a two-terminal network in the present invention.

FIG. 13-2 is a diagram of a relationship between frequency and impedance Z of an LC parallel loop.

FIG. 14 is a schematic circuit diagram of Embodiment 2 of the present invention.

FIG. 15 is a schematic circuit diagram of Embodiment 3 of the present invention.

FIG. 16 is a schematic circuit diagram of a well-known full-wave rectifier circuit.

FIG. 17 is an oscillogram of normal output of the present invention and the prior art.

FIG. 18 is a waveform of a main transformer in the prior art after the output is short-circuited.

FIG. 19 is a waveform of a main transformer in the present invention after the output is short-circuited.

### DETAILED DESCRIPTION

To facilitate understanding of the technical solution of the present invention, explanations are first provided on technical terms involved in the present invention.

Center tap: a connection point that is formed by connecting in series undotted terminals of a transformer's two windings having the same turn number. Usually a center tap may be formed using bifilar duplex windings wherein a head is connected with a tail. In special applications, two windings whose undotted terminals are connected in series may have different turn numbers.

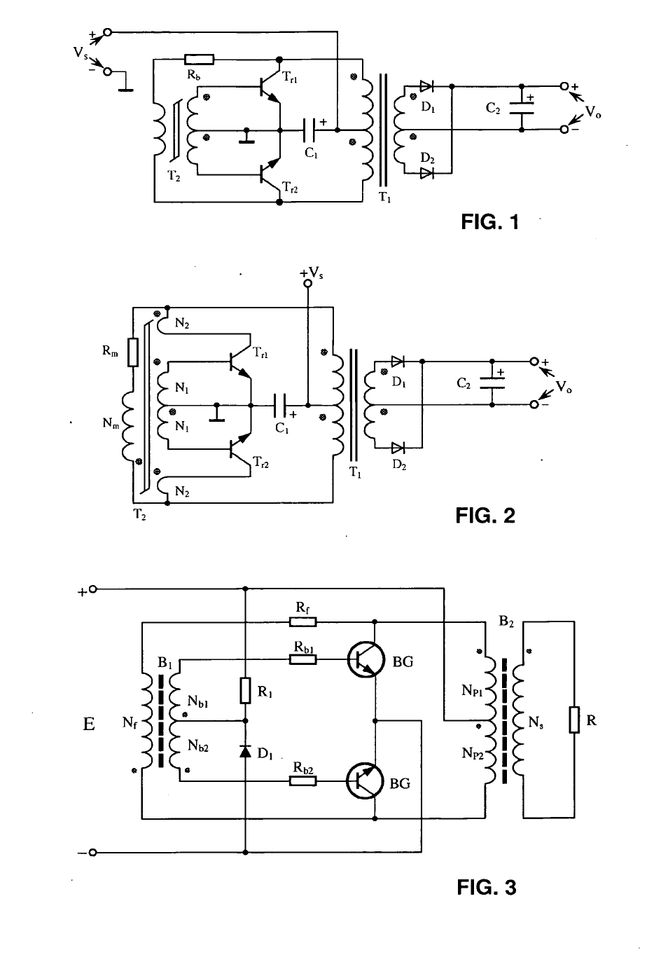

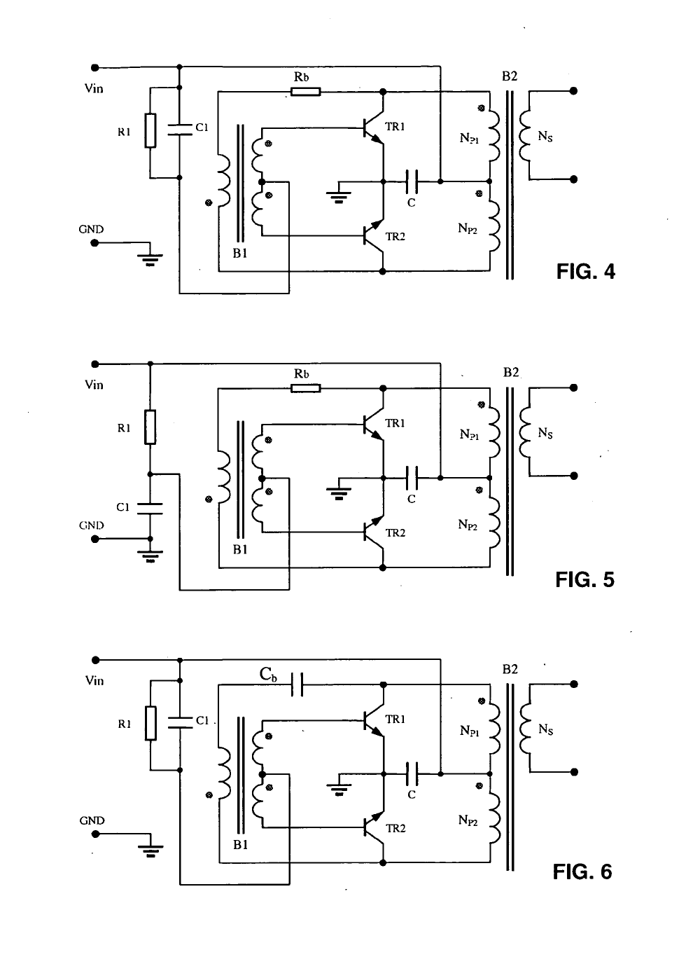

Magnetic saturation transformer: in a self-excited push-pull Jensen circuit, it is used for directly controlling conversion in a push-pull triode state and realizing a self-oscillating frequency and driving function, where one terminal of the primary winding is connected with a collector of the push-pull triode, and the other terminal is connected with a collector of another push-pull triode via a feedback resistor; two terminals of the secondary winding are connected with bases of push-pull triodes, and a center tap of the secondary winding is grounded or connected with an auxiliary starting circuit. Transformer T₂ in FIG. 1, transformer T₂ in FIG. 2, transformer B₁ in FIG. 3, transformer B₁ in FIG. 4 and transformer B₁ in FIG. 5 are all magnetic saturation transformers.

Main transformer: it is a linear transformer for transmitting energy to load, converting a voltage to a desired value and working in a non-saturation state, wherein a primary center tap is connected with a power supply, two primary terminals are connected with two collectors of push-pull triodes, and a secondary winding is connected with a rectifier circuit or load. Transformer T₁ in FIG. 1, transformer T₁ in FIG. 2, transformer B₂ in FIG. 3, transformer B₂ in FIG. 4 and transformer B₂ in FIG. 5 are all main transformers.

Feedback resistor: in a self-excited push-pull Jensen circuit, it is a resistor connected in series with a primary side of the magnetic saturation transformer, where two terminals connected in series are connected with two collectors of push-pull triodes. Resistor R_{b} in FIG. 1, resistor Rₘ in FIG. 2, resistor R_{f} in FIG. 3, resistor R_{b} in FIG. 4 and resistor R_{b} in FIG. 5 are feedback resistors.

Detailed illustration of the present invention is presented below with reference to the accompanying drawings and particular embodiments.

FIG. 6 shows a self-excited push-pull converter according to Embodiment 1 of the present invention, whose circuit structure is substantially the same as that of the Jensen circuit shown in FIG. 4 except that capacitor C_{b} replaces feedback resistor R_{b} in the Jensen circuit shown in FIG. 4. Due to the circuit symmetry, in fact, capacitor C_{b} may be serially connected between a primary winding of magnetic saturation winding B₁ and a collector of triode TR2, which will have the same effect; or one more capacitor C_{b1} is added between the primary winding of magnetic saturation winding B₁ and the collector of triode TR2, also with the same effect.

The working principle is as below: after the feedback resistor of the self-excited push-pull converter is replaced by a capacitor, the circuit's working mode changes in a short circuit condition, but it doesn't change substantially in normal operation. The following will describe this in three stages:

I. In Normal Operation

In normal operation, capacitor C_{b}, having a similar functionality to feedback resistor R_{b}, is serially connected at the primary side of magnetic saturation transformer B₁, refraining magnetic saturation transformer B₁ from consuming more energy as entering magnetic saturation. Therefore, in the present invention, capacitor C_{b} replacing feedback resistor R_{b} should be selected so that under a normal working frequency capacitive reactance of capacitor C_{b} is equal to impedance of feedback resistor R_{b}. In fact, after relaxing the restriction on power dissipation caused by magnetic saturation transformer R_{b}, capacity of capacitor C_{b} may be selected in a wide range.

The working principle in normal operation is as follows: like a circuit using a feedback resistor, at the moment when a power supply is turned on, the power supply provides a base current to the base and emitter of triodes TR1 and TR2 through a parallel loop of bias resistor R₁ and capacitor C₁ and the secondary winding of magnetic saturation transformer B₁, and then the two triodes are switched on. Since characteristics of the two triodes might not be completely identical, one of the triodes will be switched on first and its collector current is a little bit larger. Suppose triode TR2 is first switched on, and a collector current I_{c2} is generated. A voltage at a corresponding primary winding N_{P2} is positive up and negative down, i.e. a collector voltage triode TR2 is lower than a collector voltage of triode TR1. The voltage is applied via capacitor C₁ to the primary side of magnetic saturation transformer B₁. A primary voltage of magnetic saturation transformer B₁ is higher up and lower down or positive up and negative down. According to the dotted terminal relationship, a secondary induced voltage of magnetic saturation transformer B₁ is positive up and negative down. The secondary induced voltage increases the base current of triode TR2; this is a process of positive feedback, because triode TR2 will be saturation switched on soon. Accordingly, a voltage at a coil winding corresponding to the base of triode TR1 is negative up and positive down. This voltage reduces the base current of triode TR1, and triode TR1 will be completely switched off soon.

As triode TR1 is completely switched off while triode TR2 is saturation switched on, the collector voltage difference between triodes TR1 and TR2 reaches the maximum, and the voltage difference is positive up and negative down. By charging the primary side of magnetic saturation transformer B1 through capacitor C_{b}, the primary charging current of magnetic saturation transformer B1 tends to increase. However, as the primary wound turn number of magnetic saturation transformer B1 is relatively large, in order to obtain magnetic saturation characteristics, the magnetic induction intensity produced by the primary charging current of magnetic saturation transformer B1 increases with time. When the magnetic induction intensity increases to a saturation point Bₘ of the magnetic core of magnetic saturation transformer B₁, the coil's inductance decreases rapidly but does not equal zero. At this moment, a secondary induced voltage of magnetic saturation transformer B₁ tends to disappear, the base current, essential condition for triode TR2 to be saturation switched on reduces significantly, and a corresponding collector current reduces synchronously. This also is a process of positive feedback, so triode TR2 is caused to be switched off completely. When the magnetic core of magnetic saturation transformer B₁ reaches the saturation point Bₘ, the coil's inductance decreases rapidly but does not equal zero. Since current in the inductor will not disappear suddenly, by the flyback action, a voltage with the opposite polarity is induced at the secondary side of magnetic saturation transformer B₁. This induction principle is widely applied to single-ended flyback converters and belongs to common techniques in the art. The inducing of a voltage with the opposite polarity at the secondary side of magnetic saturation transformer B₁ causes another triode TR1 to be switched on. Afterwards, this process is repeated, thereby forming push-pull oscillation.

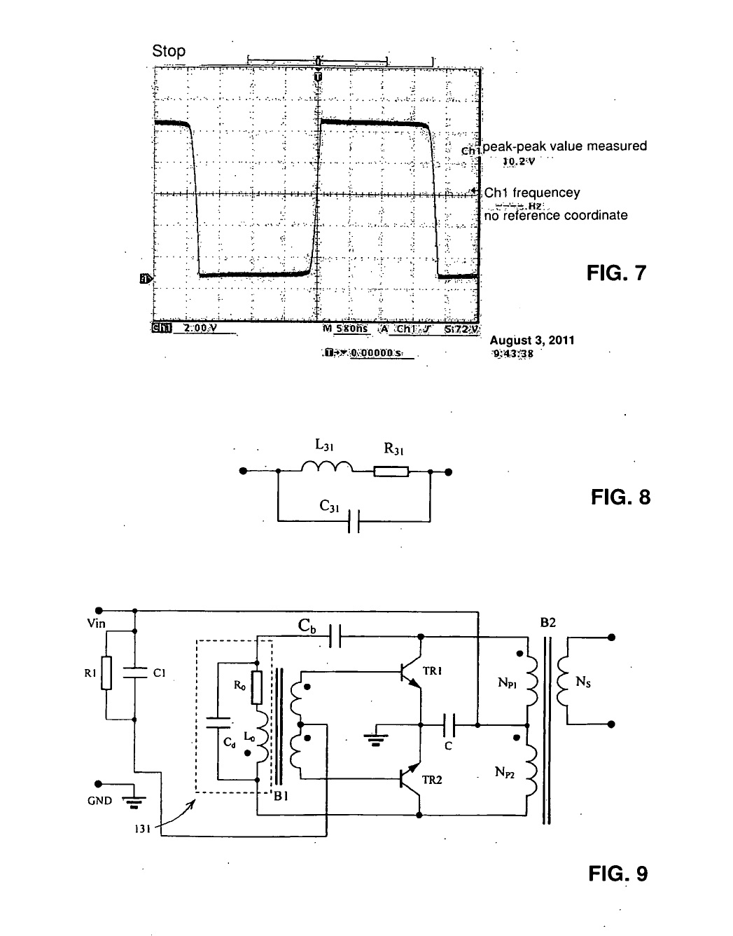

In normal operation, an oscillogram of the collector of triode TR1 is as shown in FIG. 7. As seen from this figure, the collector of triode TR1 approaches 0V when being saturation on, and approaches one time of the supply voltage when being off. This is because when triode TR2 is saturation on, an equivalent voltage of a primary winding NP1 of main transformer B2 corresponding to the collector of triode TR1 is generated by magnetic induction, which is superimposed with an original supply voltage. In fact, the principle that the self-excited push-pull Jensen converter forms push-pull oscillation is more complex than the above described. The magnetic induction intensity produced by the primary charging current of magnetic saturation transformer B1 increases with time. When the magnetic induction intensity increases to the saturation point Bₘ of the magnetic core of magnetic saturation transformer B₁, the coil's inductance decreases rapidly but does not equal zero. At this moment, the secondary induced voltage of magnetic saturation transformer B₁ tends to disappear; the base current, essential condition for triode TR2 to be saturate-switched on reduces significantly, and a corresponding collector current reduces synchronously. The collector voltage of triode TR1 reduces from an original 2-times supply voltage due to electromagnetic induction. This is a process of positive feedback, so triode TR2 is caused to be switched off completely. This conversion process is produced due to electromagnetic induction, and does not proceed fast due to the effect of a maximum working frequency of the triode and working inductance. This is also the reason why, as seen from FIG. 11, there are rise time and fall time between saturation switch on and switch off of the triode.

II. In Condition of Output Short Circuit

As the original feedback resistor R_{b} is replaced by capacitor C_{b} with an electrical property of passing high frequencies while blocking low frequencies, the circuit's working state changes. The circuit no longer enters an oscillation stop state but, due to the existence of capacitor C_{b}, the circuit enters a high-frequency self-excited working state.

The working process is described in detail as follows: All transformers have leakage inductance (in this sense, there is no ideal transformer). Leakage inductance means that not all magnetic field lines produced by a primary coil can pass through a secondary coil. The inductance that produces magnetic leakage is called leakage inductance. Usually the secondary coil is used for output and is also called secondary side. When the secondary coil is directly short-circuited, it is measured at this point that the primary coil still has an inductance amount, which is approximately taken as leakage inductance. When the load is short-circuited, this is equivalent to that the inductance amount of primary winding N_{P1} and primary winding N_{P2} of main transformer B₂ falls to a very small value. As the inductance amount falls, the collector change of triode TR1 or TR2 becomes faster than in normal operation, and the period becomes shorter. The signal is fed back to magnetic saturation transformer B₁ through capacitor C_{b}. Since the internal resistance of capacitor C_{b} is reduced under a high frequency, the feedback is strengthened. It is a well-known property of switching mode power supply materials that under a high frequency the transmission efficiency of magnetic saturation transformer B₁ is reduced. After the feedback voltage obtained by triode TR1 or TR2 is reduced while the frequency increases, the decrease of the internal resistance of capacitor C_{b} makes up the decrease of the feedback voltage, so that the circuit maintains oscillation under a high frequency. In the prior art, however, when a feedback resistor is used, as the resistor lacks the property of passing high frequencies while blocking low frequencies, when short circuit occurs, the circuit presents decaying oscillation and stops oscillation completely within 3 periods.

The working frequency rise directly causes the circuit to depart from magnetic core saturation oscillation, the current in magnetic saturation transformer B₁ cannot reach a large current in a short period, so the circuit cannot enter magnetic saturation push-pull operation but enter LC loop high-frequency oscillation. There exists distributed capacitance between turns of the coil of any inductor and transformer, with the equivalent circuit being as shown in FIG. 8. This figure is a known equivalent schematic circuit diagram for all inductors.

The primary side of magnetic saturation transformer B₁ may also take as being equivalent to the circuit in FIG. 8. Thus, when the entire circuit in FIG. 6 is working under a higher working frequency, the circuit may be equivalent to what is shown in FIG. 9, wherein a dotted box 131 is the equivalent circuit. It can be seen that this is a typical LC oscillating loop. Since capacitor C_{d} is a distributed capacitor, the oscillating frequency is unstable and has large drift. In addition, since the load of the LC loop is the base and emitter of the push-pull triode, it is equivalent to a diode. With respect to the consumption produced by the base and emitter of the push-pull triode due to switch on, although the transmission efficiency of magnetic saturation transformer B₁ decreases slightly under a high frequency, the primary consumption is not large, the primary equivalent LC loop may still work under a lower Q value and forms oscillation, and eventually the circuit's oscillating frequency will be maintained at a high frequency.

If the oscillating frequency further rises for some reason, since the transmission efficiency of magnetic saturation transformer B₁ decreases slightly, the induced voltage obtained by the base and emitter of the push-pull triode is insufficient, and the oscillating frequency cannot be maintained and falls to a stable lower frequency.

At this moment, for main transformer B₂, since the transmission efficiency decreases slightly, primary loss converted from the loss caused by secondary short circuit is not larger, so the circuit does not stop oscillation but works under a higher frequency and the circuit's working current may be controlled within a lower range.

After the condition of overcurrent and short circuit disappears, the inductance amount of primary windings N_{P1} and N_{P2} of main transformer B₂ is restored to normality. As the inductance amount increases, the collector current of triode TR1 or TR2 changes more slowly than under a high frequency, the period becomes longer, and the collector voltage directly enters switch off or saturation because the inductance amount of primary windings N_{P1} and N_{P2} of main transformer B₂ is restored to normality. This signal is fed back to magnetic saturation transformer B₁ through capacitor C_{b}. Since under a lower frequency the internal resistance of capacitor C_{b} increases, the feedback is weakened. However, the time for charging the primary side of magnetic saturation transformer B1 through capacitor C_{b} prolongs accordingly, and the circuit's oscillating frequency reduces. Through several or dozens of periods, the circuit finally goes back to oscillation using the magnetic saturation property of magnetic saturation transformer B1. The circuit's self-restoring function is achieved, that is, after the converter's overcurrent and short circuit disappear, the circuit may be restored by itself to normal operation and output a nominal voltage.

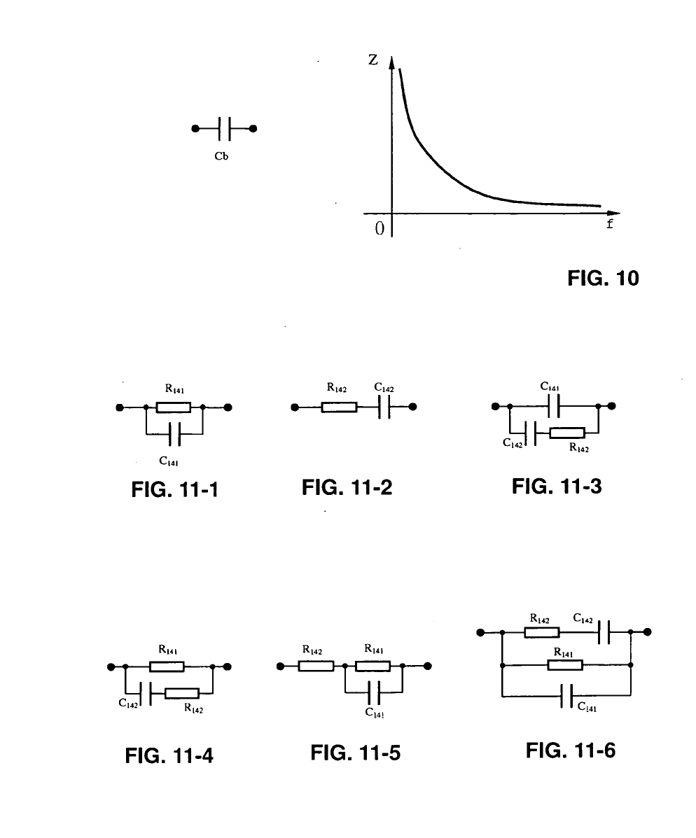

FIG. 10 shows a diagram of the relationship between frequency and impedance Z of capacitor C_{b} according to Embodiment 1 of the present invention, representing an electrical property of passing high frequencies while blocking low frequencies. The implementation principle of Embodiment 1 is to use a two-terminal network (with electrical property of passing high frequencies while blocking low frequencies) as a feedback circuit to replace feedback resistor R_{b} in the prior art. However, the embodiments of the present invention is not limited to Embodiment 1; other 8 embodiments of a two-terminal network are enumerated as below, and other circuit connection mode of the self-excited push-pull converter is the same as Embodiment 1 and thus is not detailed here again.

FIG. 11-1 shows an embodiment of a two-terminal network in the present invention, comprising resistor R₁₄₁ and capacitor C₁₄₁ that are connected in parallel.

FIG. 11-2 shows an embodiment of a two-terminal network in the present invention, comprising resistor R₁₄₂ and capacitor C₁₄₂ that are connected in parallel.

FIG. 11-3 shows an embodiment of a two-terminal network in the present invention, comprising capacitor C₁₄₁, capacitor C₁₄₂ and resistor R₁₄₂, resistor R₁₄₂ and capacitor C₁₄₂ being connected in series, the series branch being connected in parallel with capacitor C₁₄₁.

FIG. 11-4 shows an embodiment of a two-terminal network in the present invention, comprising resistor R₁₄₁, capacitor C₁₄₂ and resistor R₁₄₂, resistor R₁₄₂ and capacitor C₁₄₂ being connected in series, the series branch being connected in parallel with resistor R₁₄₁.

FIG. 11-5 shows an embodiment of a two-terminal network in the present invention, comprising resistor R₁₄₂, resistor R₁₄₁ and capacitor C₁₄₁, resistor R₁₄₁ and capacitor C₁₄₁ being connected in parallel, the parallel branch being connected in series with resistor R₁₄₂.

FIG. 11-6 shows an embodiment of a two-terminal network in the present invention, comprising resistor R₁₄₂, capacitor C₁₄₂, resistor R₁₄₁ and capacitor C₁₄₁, resistor R₁₄₂ and capacitor C₁₄₂ being connected in series, the series branch being connected in parallel with resistor R₁₄₁ and capacitor C₁₄₁.

The six embodiments of a two-terminal network as shown in FIGS. 11-1 to 11-6 each have an electrical property of passing high frequencies and blocking low frequencies, and the implementation principle and the manner in which they are applied to a self-excited push-pull converter are the same as those of Embodiment 1 and thus are not repeated here. For a self-excited push-pull converter employing a two-terminal network shown in FIG. 11-1, 11-4, 11-5 or 11-6, since resistor R₁₄₁ provides a DC branch, after the output short circuit disappears, the recovery time for entering normal operation is even shorter. This is because resistor R₁₄₁ provides a DC loop, current of magnetic saturation transformer B1 can easily reach a value sufficient to cause magnetic saturation, and the self-excited push-pull converter can get a shorter recovery time.

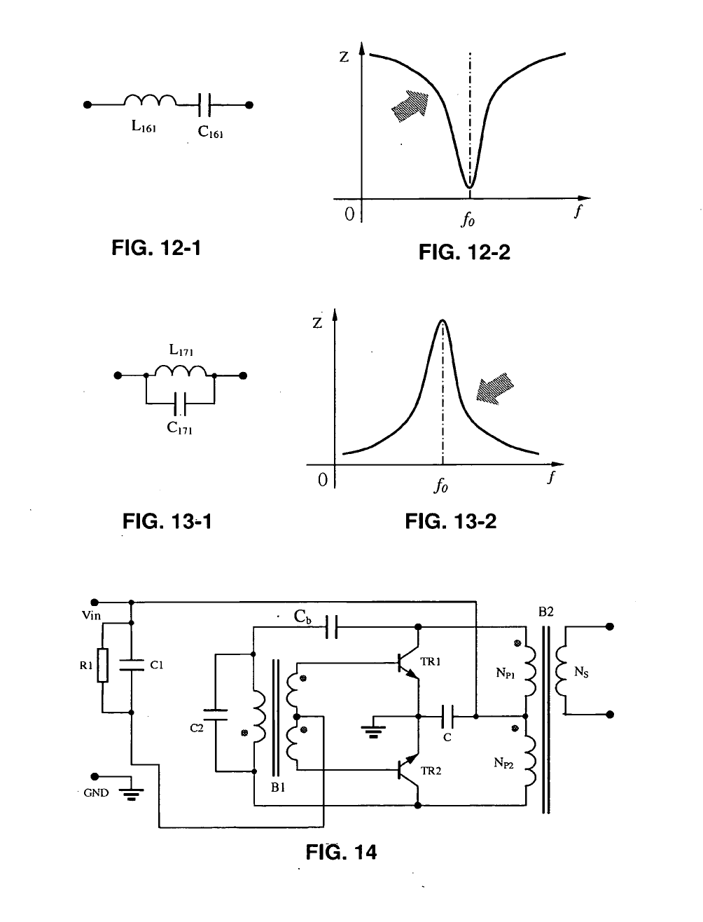

FIG. 12-1 shows an embodiment of a two-terminal network in the present invention, comprising inductor L₁₆₁ and capacitor C₁₆₁ that are connected in series. FIG. 12-2 shows a relationship diagram between frequency and impedance Z of an LC series loop, where by using characteristics of a curve from a low frequency to ƒ₀, the series circuit formed by inductor L₁₆₁ and capacitor C₁₆₁ has an electrical property as passing high frequencies and blocking low frequencies in a range between a low frequency point and ƒ₀, so that a self-excited push-pull converter employing the two-terminal network shown in FIG. 12-1 and Embodiment 1 of the present invention can achieve the same technical effect and have the same working principle.

FIG. 13-1 shows an embodiment of a two-terminal network in the present invention, comprising inductor L₁₇₁ and capacitor C₁₇₁ that are connected in parallel. FIG. 13-2 shows a relationship diagram between frequency and impedance Z of an LC parallel loop, wherein by using characteristics of a curve from ƒ₀ to a high frequency point, the parallel circuit formed by inductor L₁₁₁ and capacitor C ₁₁₁ has an electrical property as passing high frequencies and blocking low frequencies in the range between ƒ₀ and a high frequency, so that a self-excited push-pull converter employing the two-terminal network shown in FIG. 13-1 and Embodiment 1 of the present invention can achieve the same technical effect and have the same working principle.

FIG. 14 shows a self-excited push-pull converter according to Embodiment 2 of the present invention, whose circuit structure is substantially the same as that of Embodiment 1 except that capacitor C₂ is connected in parallel with the primary winding of magnetic saturation transformer B1. The working principle of Embodiment 2 is substantially the same as that of Embodiment 1 except the following: due to the addition of capacitor C₂, when the output is short-circuited, the circuit's oscillating frequency may be adjusted at high frequencies, the capacity of capacitor C2 is adjusted to exert so that it has no impact on the circuit during normal operation but, when short-circuited, it can control the circuit's oscillating frequency at the high end to be within designed range. The oscillating frequency of oscillation that used to rely on distributed capacitance tends to have a large drift, and addition of capacitor C2 can improve the product consistency in this respect.

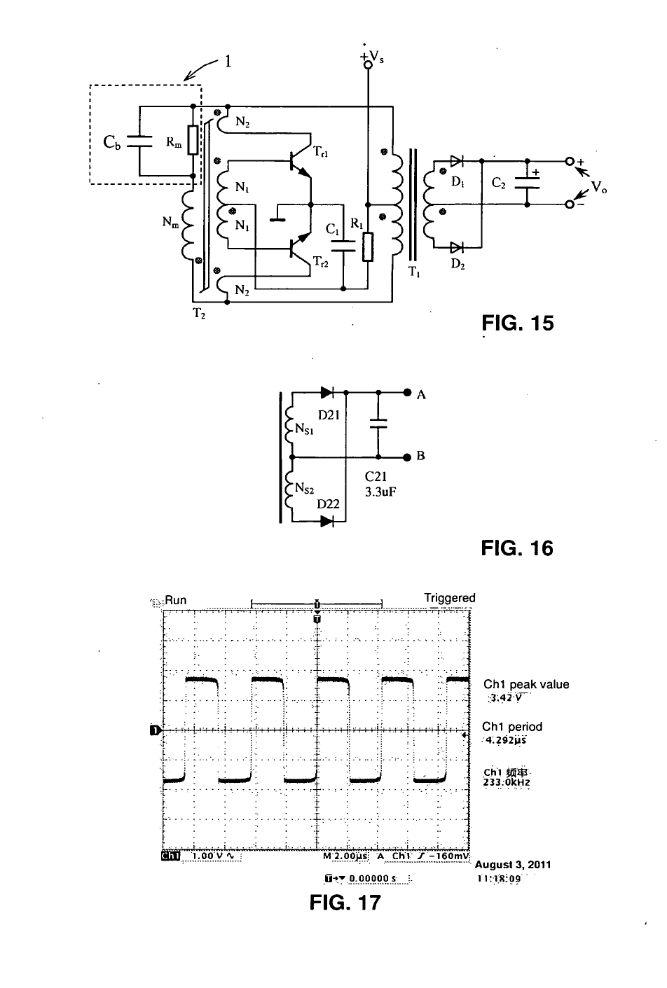

FIG. 15 shows a self-excited push-pull converter according to Embodiment 3 of the present invention, whose circuit structure is substantially the same as that of the Jensen circuit shown in FIG. 2 except that capacitor C_{b} is added. Capacitor C_{b} is connected in parallel with feedback resistor Rₘ, one path of a center tap of the secondary winding of magnetic saturation transformer T₂ is connected through capacitor C₁ to the circuit's supply reference terminal, and the other path is connected through resistor R₁ to the circuit's supply terminal +Vs. Capacitor C_{b} and feedback resistor Rₘ form a two-terminal network 1 having a property of passing high frequencies and blocking low frequencies. A line auxiliary starting circuit is formed by resistor R₁ and capacitor C₁. It should be pointed out that in FIG. 2 capacitor C₁ is the source capacitor, while in this embodiment capacitor C₁ is a component of the line auxiliary starting circuit.

The working principle of Embodiment 3 is as follows:

During normal operation, capacitor C_{b} has a large capacitive reactance, resistor Rₘ plays the main role, and the circuit still works in self-excited push-pull controlled by magnetic saturation transformer T2.

When the output is short-circuited, like Embodiment 1, the circuit enters a high-frequency self-excited oscillation working mode due to the action of two-terminal network 1. At this moment, since the transmission efficiency of main transformer T1 decreases slightly, the primary loss of main transformer T1 converted from the loss caused by secondary short circuit is not quite large. In this manner, the circuit does not stop oscillation, and the circuit's working current can be controlled within a low range, thereby achieving the object of the present invention.

In Embodiment 3, two-terminal network 1 shown in FIG. 15 may be replaced by a capacitor or a two-terminal network shown in FIG. 11-2, 11-3, 11-4, 11-5 or 11-6. The object of the present invention can also be achieved.

As a further improvement over Embodiments 1-3, an inductor may be serially connected from the supply terminal to the main transformer's center tap. The inductor's inductance amount is selected so that it exert little impact on the circuit's conversion efficiency in normal operation. When the output is short-circuited, by means of the inductor's property of passing low frequencies and blocking high frequencies, a large voltage drop is produced, the energy transmission of the main transformer to the short-circuited output is reduced, and the circuit's working current is further decreased and the circuit's power dissipation is further lowered when output short circuit occurs.

As a further improvement over Embodiments 1-3, a capacitor is connected in parallel at two connection points between the main transformer and the collectors of the push-pull triodes. In this manner, it is possible to improve the unstable circuit operation caused when distributed capacitance of the main transformer is too small, and in the meanwhile, it is possible to stabilize an LC loop of the distributed capacitance and the leakage inductance of the main transformer in case of output short circuit, further reduce the circuit's working current in case of output short circuit and further lower the circuit's power dissipation.

The above improved schemes may be used in combination, i.e. connecting in parallel a capacitor at the primary winding of the magnetic saturation transformer, connecting in series an inductor from the supply terminal to the main transformer's center tap, and connecting in parallel a capacitor at two connection points between the main transformer and the collectors of the push-pull triodes.

Further illustration is presented below on advantageous effects of the present invention with reference to actual measured data.

Tables 1 and 2 show a comparison of measured data between the self-excited push-pull Jensen converter (as shown in FIG. 6) of the present invention and the Jensen circuit (as shown in FIG. 4) of the prior art. For the comparison test, 5V-to-5V DC/DC converters were made based on the circuit shown in FIG. 4, and the output power is 1 W, (output current is 200 mA).

The circuit's typical parameters: supply input voltage Vin is 5V, bias resistor R1 is 2.21 kΩ, feedback resistor Rb is 2.21 KΩ, triodes TR1 and TR2 use T0-92 packaged 2N5551 with maximum collector working current of 600 mA, maximum collector consumption of 625 mW and amplification factor of 180, capacitor C1 is a 0.1 uF chip capacitor, and capacitor C is a 1 uF chip capacitor.

Magnetic saturation transformer B1 has a primary side of 50 turns and a secondary side of 5 turns+5 turns, main transformer B2 has a primary side of 8 turns+8 turns and a secondary side employing a 9 turns+9 turns full-wave rectifier circuit structure having a center tap as shown in FIG. 16. Both magnetic saturation transformer B1 and main transformer B2 use a magnetic core of a PC95 material and a magnetic ring with an external diameter of 4.3 mm, an internal diameter of 1.5 mm and a height of 1.8 mm; both are wound using enameled wires with a diameter of 0.11 mm; the primary side of magnetic saturation transformer B1 is wound with 50 turns, so as to get the magnetic saturation performance. The output circuit employs the full-wave rectifier circuit shown in FIG. 16, which is a well-known circuit. Since the working frequency is relatively high, capacitor C21 employs a 3.3uF chip capacitor.

Except replacing feedback resistor Rb by a 330 uF capacitor, the self-excited push-pull Jensen converter (as shown in FIG. 6) of the present invention have the same circuit parameters as indicated above.

In order not to affect a test result, main transformer B2 is wound with 3 more turns as a detection winding, so as to reduce the impact of an oscilloscope on the tested circuit.

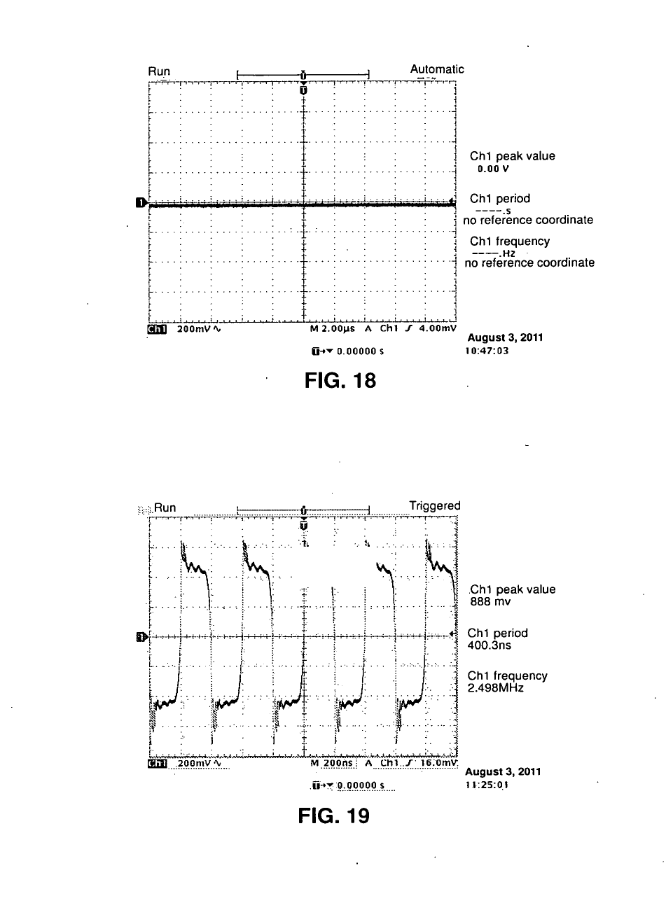

TABLE 1

| | | | The present |
|---|---|---|---|
| | | | invention (resistor |
| Number | | | Rb being replaced |
| of test | Explanations of | | by a 330 pF |
| item | test items | Prior art | capacitor) |
| 1 | waveform in main | refer to FIG. 17 | refer to FIG. 17 |
| | transformer during | | (annotation 1) |
| | normal operation | | |
| 2 | no-load working | 18.5 mA | 18.7 mA |
| | current | | |
| 3 | waveform in | refer to FIG. 18 | refer to FIG. 19 |
| | main transformer | working frequency: | working frequency: |
| | when the output | oscillation stop | 2.498 MHz |
| | is short-circuited, | | |
| | i.e. points A and | | |
| | B in FIG. 16 are | | |
| | short-circuited | | |

Annotation 1: actual frequency is 233.9 KHz, frequency offset is less than 0.43%, see FIG. 17.

As seen from Table 1, with normal working frequency still at 233 KHz, when the output is short-circuited, for the converter of the prior art, oscillation stops, whereas for the converter of the present invention, the working frequency shifts upwards to 2.498 MHz. In order to further explain advantageous effects of the present invention, other recorded data are shown in Table 2.

TABLE 2

| | | | The present |
|---|---|---|---|
| | | | invention (resistor |
| Number | | | Rb being replaced |
| of test | Explanations | | by a 330 pF |
| item | of test items | Prior art | capacitor) |
| 1 | working current | 780 mA (keep | 43 mA |
| | | increasing, see | |
| | | annotation 2) | |
| 2 | total power | 3900 mW | 215 mW |
| | consumption | | |
| | (calculated) | | |
| 3 | working | less than 3 seconds | normal after 168 |
| | duration | | hours |
| 4 | recoverability | circuit damaged | Short circuit |
| | | and unrecoverable | disappears, |
| | | | immediately |
| | | | restored to |
| | | | normality |

Annotation 2: the test can only last for a short period of time because in the prior art circuit, when short circuit, the working current quickly exceeds 2000 mA and burns the circuit in about 2 seconds.

As seen from Table 2, the present invention obtains a good self-protection performance. After the condition of short circuit and overcurrent disappears, the circuit is restored by itself to a normal working condition, and the pair of triodes for push-pull in the circuit will not be burned by over heating when short circuit occurs.

Similar conclusions can be obtained by performing the above test on Embodiment 2 and Embodiment 3, which is not repeated here.

The preferred embodiments of the present invention have been presented above. It should be pointed out that the foregoing preferred embodiments should not be construed as limiting the present invention, and the protection scope of the present invention should be determined by the claims. Several improvements and polishes may be made by those of ordinary skill in the art without departing from the scope and spirit of the present invention, which should also be regarded as the protection scope of the present invention. For example, the capacitor may be connected in series, in parallel or in parallel and series; the NPN-type triodes may be replaced by PNP-type triodes, thereby reversing the polarity of supply input voltage.

1. A self-excited push-pull converter, comprising a Jensen circuit, wherein a two-terminal network with an electrical property of passing high frequencies and blocking low frequencies exists between a terminal of a magnetic saturation transformer primary winding and a terminal of a main transformer primary winding in said Jensen circuit, i.e. said magnetic saturation transformer primary winding is connected in parallel with said main transformer primary winding through said two-terminal network.

2. The self-excited push-pull converter according to claim 1, wherein said two-terminal network is a capacitor.

3. The self-excited push-pull converter according to claim 1, wherein said two-terminal network is formed by a capacitor connected in parallel with a resistor.

4. The self-excited push-pull converter according to claim 1, wherein said two-terminal network is formed by a capacitor connected in series with a resistor.

5. The self-excited push-pull converter according to claim 1, wherein said two-terminal network is formed by more than one capacitor connected in parallel and series with more than one resistor.

6. The self-excited push-pull converter according to claim 1, wherein said two-terminal network is formed by a capacitor connected in series with an inductor.

7. The self-excited push-pull converter according to claim 1, wherein said two-terminal network is formed by a capacitor connected in parallel with an inductor.

8. The self-excited push-pull converter according to any claim 1, wherein a capacitor is connected in parallel at said magnetic saturation transformer primary winding.

9. The self-excited push-pull converter according to claim 2, where a capacitor is connected in parallel at said magnetic saturation transformer primary winding.

10. The self-excited push-pull converter according to claim 3, where a capacitor is connected in parallel at said magnetic saturation transformer primary winding.

11. The self-excited push-pull converter according to claim 4, where a capacitor is connected in parallel at said magnetic saturation transformer primary winding.

12. The self-excited push-pull converter according to claim 5, where a capacitor is connected in parallel at said magnetic saturation transformer primary winding.

13. The self-excited push-pull converter according to claim 6, where a capacitor is connected in parallel at said magnetic saturation transformer primary winding.

14. The self-excited push-pull converter according to claim 7, where a capacitor is connected in parallel at said magnetic saturation transformer primary winding.
